(19) United States
(12) Patent Application Publication
(10) Pub. No.: US 2017/0063641 A1
(43) Pub. Date: Mar. 2, 2017

(54) SERVER MANAGEMENT SYSTEM AND METHOD

(71) Applicant: HON HAI PRECISION INDUSTRY CO., LTD., New Taipei (TW)

(72) Inventor: FANG-CING SU, New Taipei (TW)

(21) Appl. No.: 14/843,073

(22) Filed: Sep. 2, 2015

(30) Foreign Application Priority Data
Aug. 26, 2015 (CN) 201510529479.2

(51) Int. Cl. H04L 12/24

(52) U.S. Cl. CPC H04L 41/24; H04L 41/22

(57) ABSTRACT

The disclosure server management provides a plurality of servers, each of the servers comprising a basic input/output system (BIOS), the BIOS is configured for collecting a hardware information of the server; a controller is configured for obtaining the hardware information from the BIOS of each of the servers; and a monitor is configured for displaying the hardware information transmitted by the controller. A server management method is also provided.

### FIELD

The subject matter herein generally relates to server management systems.

### BACKGROUND

Generally, the network administrator needs to know the hardware information of each server.

### BRIEF DESCRIPTION OF THE DRAWINGS

Implementations of the present technology will now be described, by way of example only, with reference to the attached figures.

FIG. 1 is a block diagram of an example embodiment of a server management system of the present disclosure.

FIG. 2 is a block diagram of an example embodiment of a server of FIG. 1.

FIG. 3 is a flow chart of an example embodiment of a server management method of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

A definition that applies throughout this disclosure will now be presented.

The term “comprising” means “including, but not necessarily limited to”; it specifically indicates open-ended inclusion or membership in a so-described combination, group, series and the like.

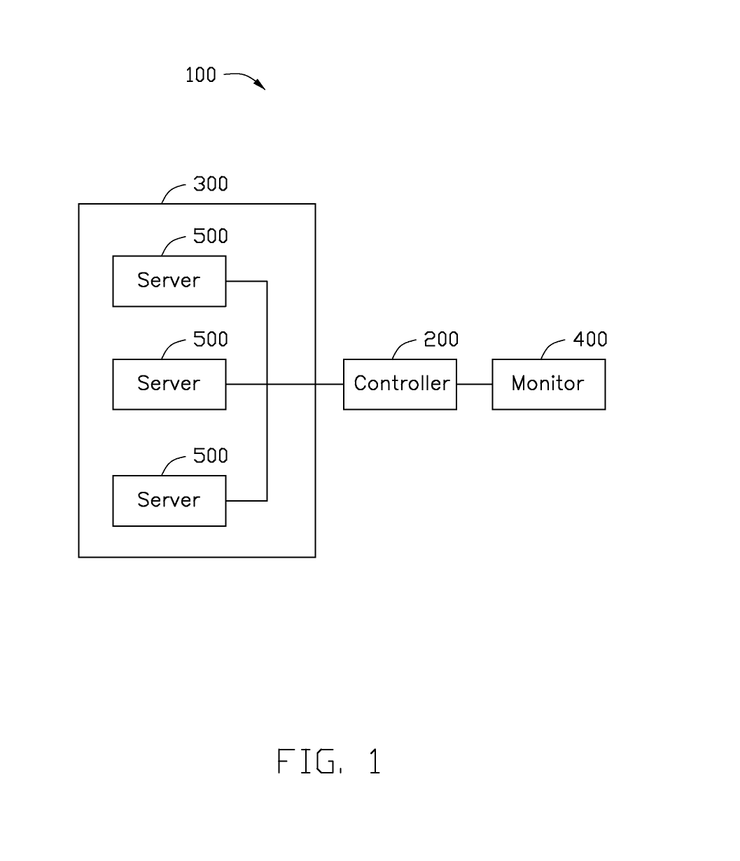

FIG. 1 illustrates a server management system 100 of the present disclosure. The server management system 100 in accordance with an exemplary embodiment can comprise a controller 200, a rack 300, a monitor 400, and a monitor plurality of servers 500. The plurality of servers 500 can be mounted in the rack 300. The controller 200 can obtain hardware information, such as serial number, computer manufacturers, serial information, and other system parts information from the server 500, and display the hardware information through the monitor 400.

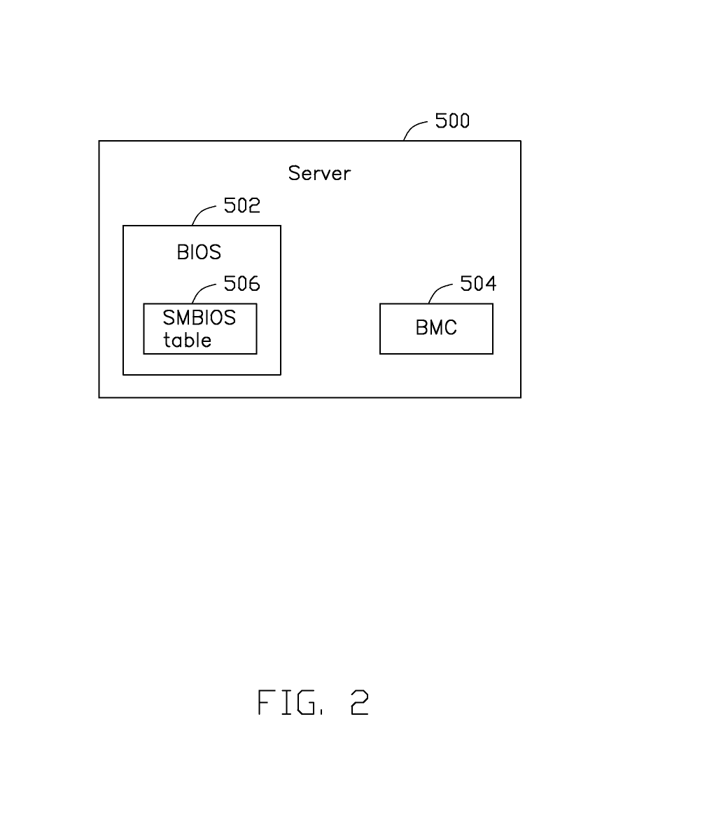

FIG. 2 is a block diagram of an example embodiment of the server 500. Each of the servers 500 can also comprise a basic input/output system (BIOS) 502, and a baseboard management controller (BMC) 504. The BIOS 502 is configured for collecting the hardware information from the server 500, and also storing the hardware information in a system management BIOS (SMBIOS) table 506. In the illustrated embodiment, the BIOS 502 collects the hardware information of the server 500 before the server 500 enters the operating system.

In the illustrated embodiment, the BMC 504 can obtain hardware information from the SMBIOS table 506 and transmit the hardware information to the controller 200.

In the illustrated embodiment, the controller 200 can obtain the hardware information from the BMC 504 and display the hardware information through the monitor 400.

In operation, the server 500 starts to perform a power initialization diagnostic program, the BIOS 502 collects the hardware information of server 500, and stores the hardware information in the SMBIOS table 506. The BMC 504 obtains the hardware information from the SMBIOS table 506, and transmits the hardware information to the controller 200. The controller 200 obtains the hardware information from the BMC 504, and displays the hardware information through the monitor 400.

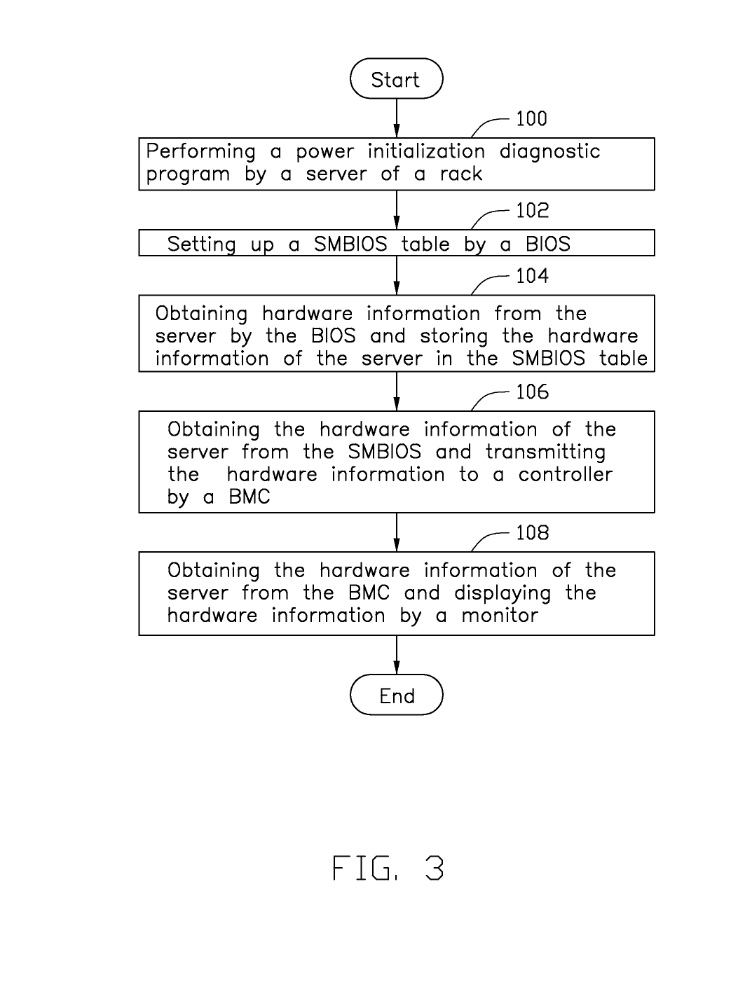

Referring to FIG. 3, a flowchart is presented in accordance with an example embodiment which is being thus illustrated. The example method is provided by way of example, as there are a variety of ways to carry out the method. The method described below can be carried out using the configurations illustrated in FIG. 1, for example, and various elements of these figures are referenced in explaining example method. Block shown in FIG. 3 represents one or more processes, methods, or subroutines, carried out in the test method. Furthermore, the illustrated order of blocks is by example only and the order of the blocks can change. Additional blocks may be added or fewer blocks may be utilized, without departing from this disclosure. The server management method can begin at block 100.

At block 100, a server 500 of the rack 300 starts to perform a power initialization diagnostic program.

At block 102, the BIOS 502 is configured to set up the SMBIOS table 506.

At block 104, the BIOS 502 collects the hardware information of the server 500, and stores the hardware information in the SMBIOS table 506. In the illustrated embodiment, the BIOS 502 collects the hardware information of the server 500 before the server 500 enters the operating system.

At block 106, the BMC 504 obtains the hardware information from the SMBIOS table 506, and transmits the hardware information of the server 500 to the controller 200.

At block 108, the controller 200 obtains the hardware information from the BMC 504, and displays the hardware information of the server 500 through the monitor 400.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A server management system comprising:
a rack;
a plurality of servers mounted in the rack, each server comprising a basic input/output system (BIOS), which is configured for collecting hardware information of the servers;
a controller configured for obtaining the hardware information from the BIOS of each of the servers; and
a monitor configured for displaying the hardware information transmitted by the controller.

2. The server management system of claim 1, wherein the server management system comprises a basic management controller (BMC), the controller obtains the hardware information from the BIOS through the BMC.

3. The server management system of claim 1, wherein the BIOS further comprises a system management BIOS (SMBIOS) table, the BIOS stores the hardware information of the server in the SMBIOS table.

4. A server management method comprising:
collecting a hardware information of a server by a basic input/output system (BIOS), and transmitting the hardware information to a basic management controller (BMC);
obtaining the hardware information from the BIOS by the BMC, and transmitting the hardware information to the a controller; and
obtaining the hardware information from the BMC by the controller, and displaying the hardware information through a monitor.

5. The server management method of claim 4, wherein the BIOS further comprises a system management BIOS (SMBIOS) table, the BIOS stores the hardware information of the server in the SMBIOS table.

6. The server management method of claim 4, wherein the BIOS collects the hardware information of the server before the server enters the operating system.
